(19) United States
(12) Patent Application Publication
(10) Pub. No.: US 2007/0223153 A1
(43) Pub. Date: Sep. 27, 2007

(54) PORTABLE ELECTRONIC DEVICES

(75) Inventor: Shan Wei Hong, Jiangsu (CN)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/690,765

(22) Filed: Mar. 23, 2007

(30) Foreign Application Priority Data
Mar. 27, 2006 (TW) TW95110548

(51) Int. Cl. H02H 7/00

(52) U.S. Cl. 361/1

(57) ABSTRACT

Portable electronic devices are provided. A portable electronic device includes a case and a rotary member. The case includes an opening and a connection portion adjacent to the opening for attachment of a strap. The rotary member is pivotally connected to the case between a first position and a second position. The opening is blocked by the rotary member when in the first position. The rotary member separates from the opening when in the second position, such that the opening is exposed on a side of the case.

### BACKGROUND OF THE INVENTION

1. Field of the Invention

The invention relates in general to portable electronic devices and in particular to portable electronic device capable of having straps tied thereto.

2. Description of the Related Art

Referring to FIG. 1, a conventional portable electronic device, such as a mobile phone, comprises a case 10 with an arm C formed in a corner thereof for attachment of a strap (not shown). As shown in FIG. 1, two openings H are communicated adjacent to the arm C. For attachment of the strap to the arm C, the strap is inserted through the openings H and knotted. However, removal or replacing of the strap can be difficult due to the fixed mechanism of the case 10.

### BRIEF SUMMARY OF THE INVENTION

Portable electronic devices are provided. A portable electronic device includes a case and a rotary member. The case includes an opening and a connection portion adjacent to the opening for attachment of a strap. The rotary member is pivotally connected to the case between a first position and a second position. The opening is blocked by the rotary member when in the first position. The rotary member separates from the opening when in the second position, such that the opening is exposed on a side of the case.

### BRIEF DESCRIPTION OF THE DRAWINGS

The invention can be more fully understood by reading the subsequent detailed description and examples with references made to the accompanying drawings, wherein:

FIG. 1 is a perspective diagram of a conventional portable electronic device;

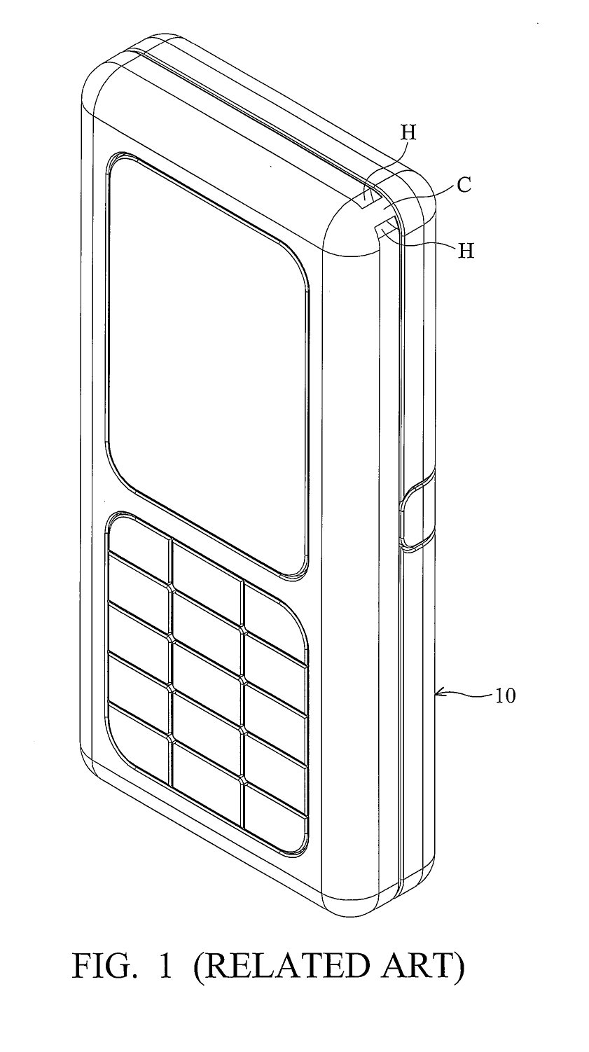

FIG. 2 is a perspective diagram of an embodiment of a portable electronic device of this invention;

FIGS. 3A and 3B are perspective diagrams of a portable electronic device when a rotary member is in a second position;

FIG. 4 is a perspective diagram of a portable electronic device with a strap tied thereto when a rotary member rotates from a second position to a first position;

FIG. 5 is a perspective diagram of a portable electronic device with a strap tied thereto when a rotary member rotates from a first position to a second position;

FIG. 6 is a perspective diagram of an abutting portion contacting a first protrusion when a rotary member is in a first position; and

FIG. 7 is a perspective diagram of an abutting portion contacting a second protrusion when a rotary member is in a second position.

### DETAILED DESCRIPTION OF THE INVENTION

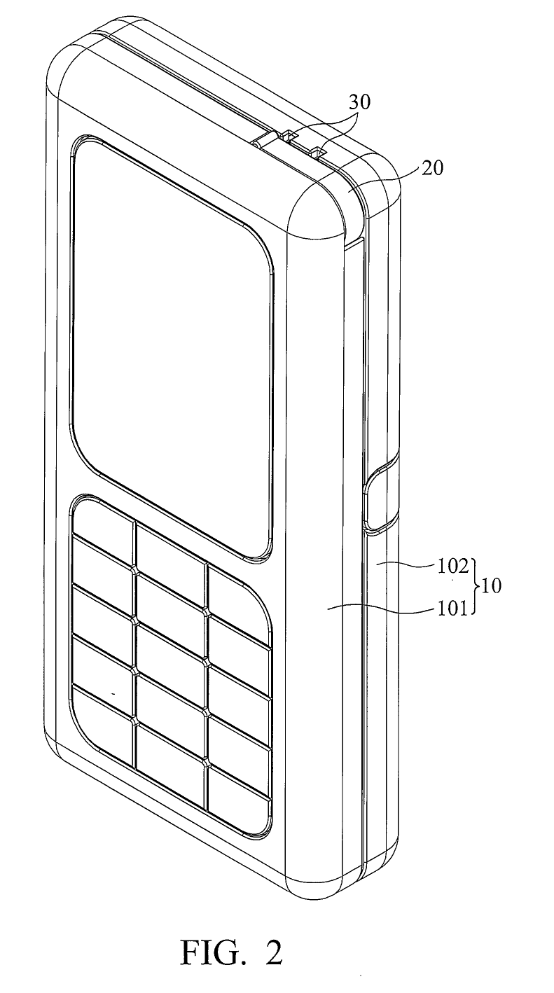

Referring to FIG. 2, an embodiment of a portable electronic device, such as a mobile phone or PDA, comprises a case 10 and rotary member 20 pivotally connected thereto. In this embodiment, the rotary member 20 is disposed in a corner of the case 10. As shown in FIG. 2, the case 10 includes a first frame 101 and a second frame 102, wherein two recesses 30 are formed on the top side of the second frame 102 for attachment of a strap to the case 10.

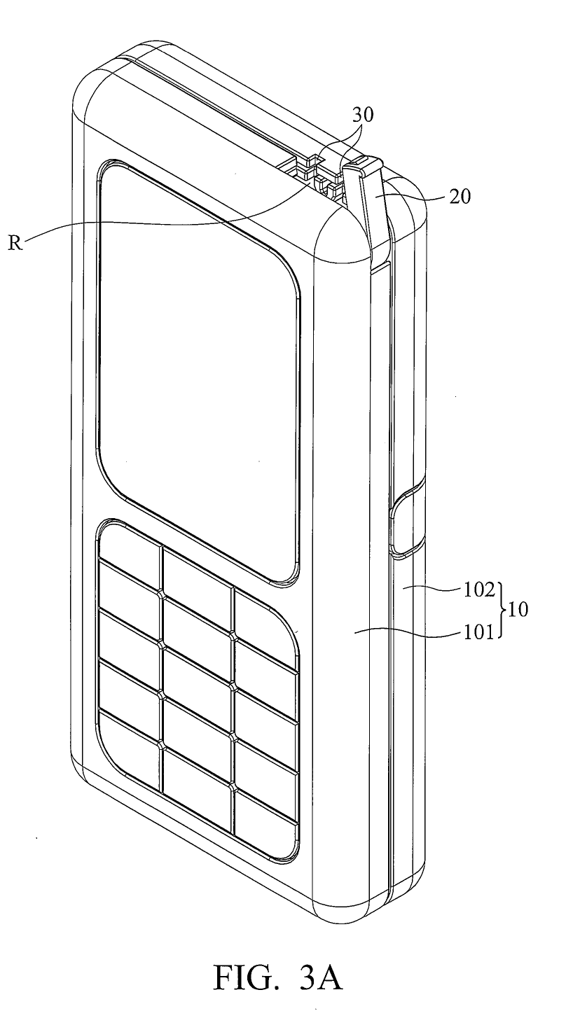

For attachment of a strap to the portable electronic device, first, the rotary member 20 is rotated along axis Z from a first position shown in FIG. 2 to a second position shown in FIG. 3. In FIG. 3, the rotary member 20 is rotated to the second position and separated from an opening R of the first frame 101, wherein the opening R and the recesses 30 are communicated and exposed to the top side of the case 10.

Referring to FIG. 3B, the second frame 102 comprises a connection portion 40 between the recesses 30, wherefrom the first frame 101 is omitted. When the rotary member 20 rotates to the second position, a strap W is hung on the connection portion 40 from the opening R and through the recesses 30, as the arrow indicates in FIG. 3B. Specifically, the rotary member 20 comprises an abutting portion 201 projecting from a surface thereof. When the rotary member 20 rotates to the first position or the second position, the abutting portion 201 contacts a part of the case 10, such that rotation of the rotary member 20 is limited between the first and second positions.

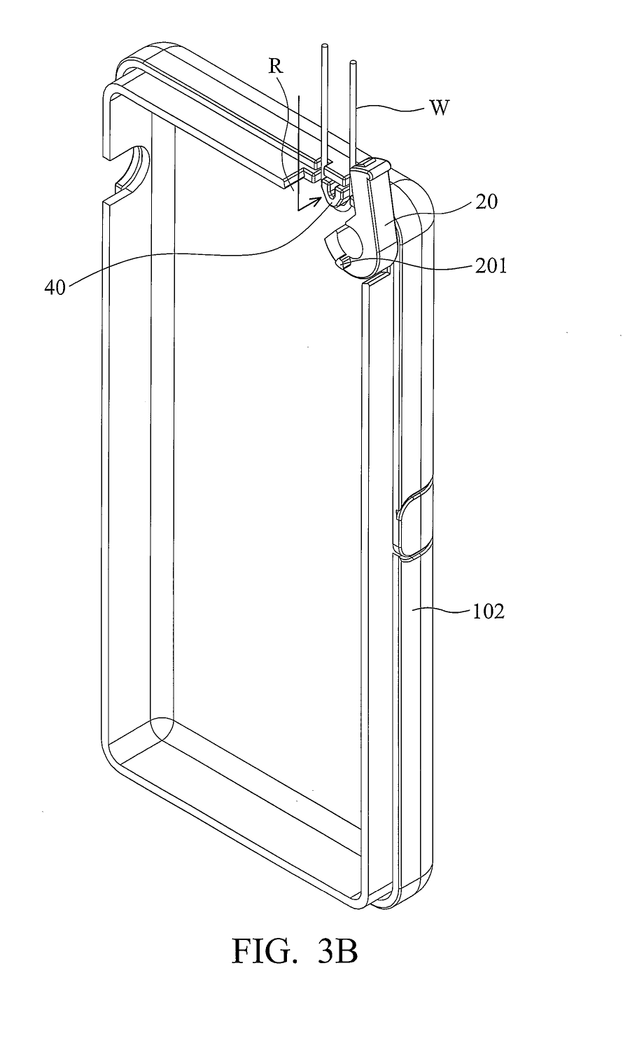

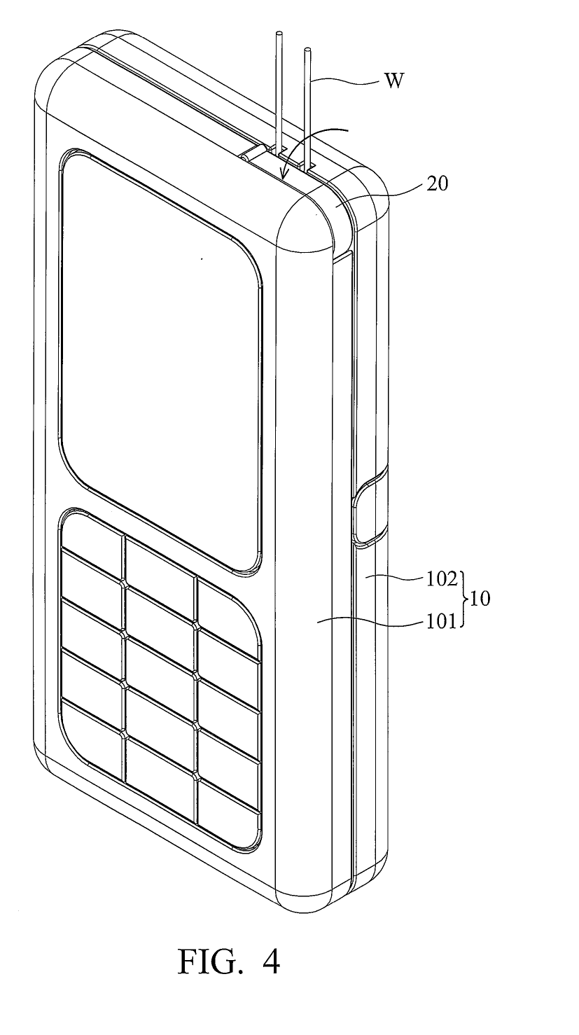

After the strap W is hung on the connection portion 40, the rotary member 20 returns from the second position to the first position, as shown in FIG. 4, such that the opening R is blocked, to prevent the strap W from dislodging. Referring to FIG. 5, when the rotary member 20 is separated from the opening R from the first position to the second position, the strap W can be released from the connection portion 40 and the case 10 via the opening R.

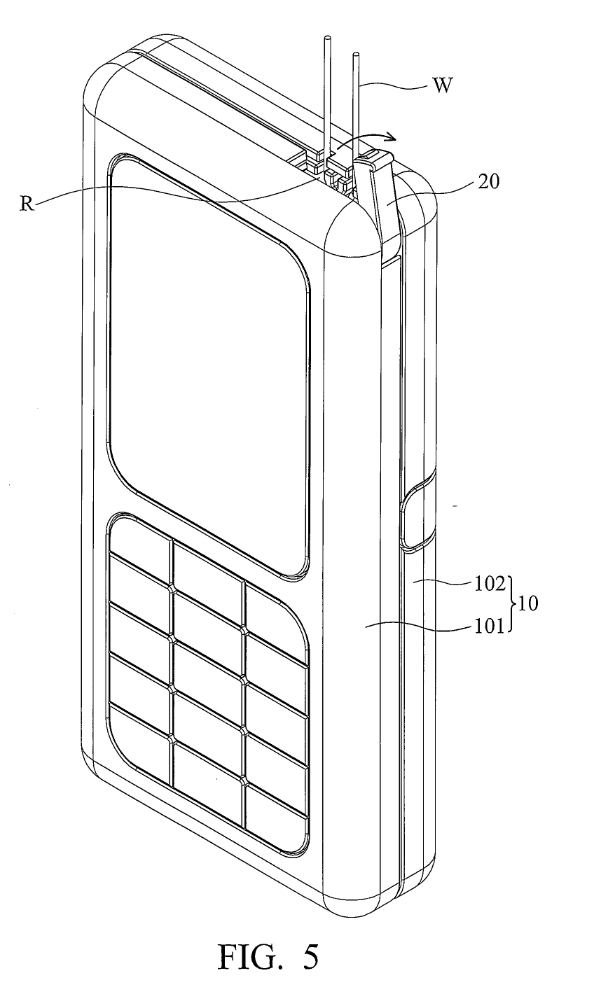

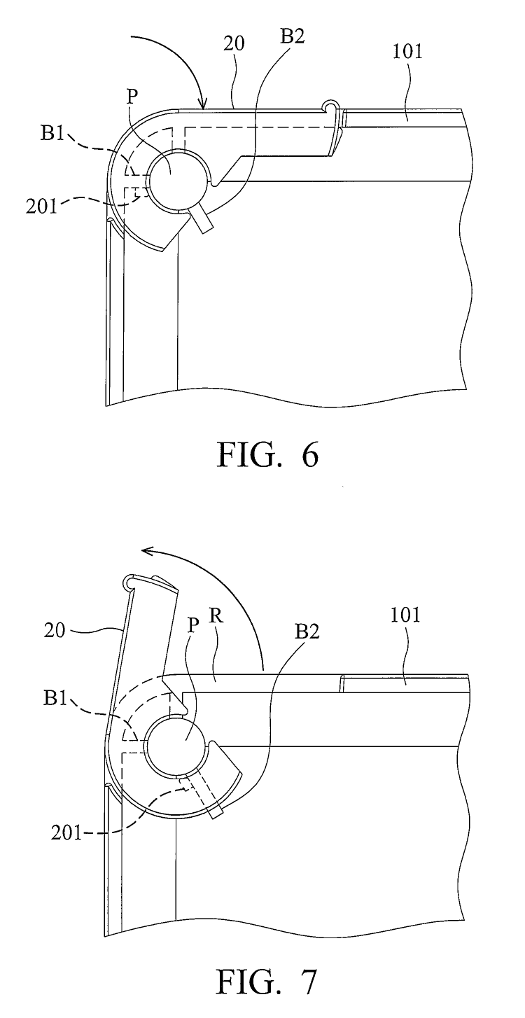

Referring to FIG. 6 and FIG. 7, the first frame 101 comprises a first protrusion B1, a second protrusion B2, and a shaft P pivotally connected to the rotary member 20. When the rotary member 20 rotates counterclockwise to the first position from the second position, as shown in FIG. 6, the first protrusion B1 of the first frame 101 contacts the abutting portion 201, to hold the rotary member 20 in the first position. Correspondingly, when the rotary member 20 rotates clockwise to the second position from the first position, as shown in FIG. 7, the second protrusion B2 of the first frame 101 contacts the abutting portion 201, to hold the rotary member 20 in the second position. Namely, rotation of the rotary member 20 is restricted between the first and second positions by the first and second protrusions B1 and B2.

In this embodiment, the first and second protrusions B1 and B2 can be stiffening ribs of the first frame 101. However, the shaft P, the first and second protrusions B1 and B2 can also be disposed on the second frame 102. In some embodiments, the shaft P, the first and second protrusions B.1 and B2 are physically connected or integrally formed in one piece.

Portable electronic devices with simple structure and low cost are provided according to the embodiment. The portable electronic device has a case and a rotary member, such that attachment and removal of straps is convenient.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A portable electronic device, comprising:
a case, comprising an opening and a connection portion adjacent to the opening for attachment of a strap; and
a rotary member, pivotally connected to the case between a first position and a second position, wherein the opening is blocked by the rotary member when in the first position, and the rotary member separates from the opening when in the second position such that the opening is exposed on a side of the case.

2. The portable electronic device as claimed in claim 1, wherein the case further comprises two recesses with the connection portion formed therebetween, wherein the recesses communicate with the opening, and the strap is accommodated in the recesses during attachment to the connection portion.

3. The portable electronic device as claimed in claim 1, wherein the case further comprises a first frame with the opening formed thereon and a second frame with the connection portion formed thereon.

4. The portable electronic device as claimed in claim 1, wherein the rotary member is disposed in a corner of the case.

5. The portable electronic device as claimed in claim 1, wherein the case further comprises a shaft pivotally connected to the rotary member.

6. The portable electronic device as claimed in claim 1, wherein the case further comprises a first protrusion, and the rotary member comprises an abutting portion contacting the first protrusion when in the first position.

7. The portable electronic device as claimed in claim 6, wherein the first protrusion is a stiffening rib of the case.

8. The portable electronic device as claimed in claim 1, wherein the case further comprises a second protrusion, and the rotary member comprises an abutting portion contacting the second protrusion when in the second position.

9. The portable electronic device as claimed in claim 8, wherein the second protrusion is a stiffening rib of the case.

10. The portable electronic device as claimed in claim 1, wherein the portable electronic device is a mobile phone.
